(19) United States
(12) Patent Application Publication
(10) Pub. No.: US 2015/0178566 A1
(43) Pub. Date: Jun. 25, 2015

(54) Transient and dynamic point of attraction determination

(71) Applicant: International Business Machines Corporation, Armonk, NY (US)

(72) Inventors: Barry Alan Kritt, Raleigh, NC (US); Sarbajit Kumar Rakshit, Kolkata (IN)

(73) Assignee: International Business Machines Corporation, Armonk, NY (US)

(21) Appl. No.: 14/140,382

(22) Filed: Dec. 24, 2013

(51) Int. Cl. G06K 9/00; G06K 9/46

(52) U.S. Cl. CPC G06K 9/00624; G06K 9/4604

(57) ABSTRACT

Events regarding a transient and dynamic point of attraction within a geographical area are received. Each event includes at least a location at which a photographer captured a photograph of the transient and dynamic point of attraction, and a compass direction the photographer was facing when capturing the photograph. A location of the transient and dynamic point of attraction within the geographical area from the events, and can be transmitted to a mobile computing device located within the geographical area.

### BACKGROUND

Mobile computing devices, such as smartphones, have become nearly ubiquitous in modern life. Many such devices have the capability of sending and receiving data wirelessly, as well as capturing digital photographs. Many such devices further having global positioning system (GPS) or other locational determination capability, as well as built-in compass functionality.

### SUMMARY

An example method includes receiving, by a computing device, events regarding a transient and dynamic point of attraction within a geographical area. Each event includes a location at which a photographer captured a photograph of the transient and dynamic point of attraction, and a compass direction the photographer was facing when capturing the photograph. The method includes determining, by the computing device, a location of the transient and dynamic point of attraction within the geographical area from the events.

An example computer program product includes a storage device storing computer-executable code that is executable by a mobile computing device to perform a method. The method includes receiving a location of a transient and dynamic point of attraction within a geographical area in which the mobile computing device is located. The location is determined from events regarding the transient and dynamic point of attraction. Each event includes a location at which a photographer captured a photograph of the transient and dynamic point of attraction, and a compass direction the photographer was facing when capturing the photograph. The method includes indicating the location of the transient and dynamic point of attraction within a map displayed on the mobile computing device.

An example system includes network communication hardware to communicate with mobile computing devices located within a geographical area. The system includes a processor and a storage device storing computer-executable code executable by the processor. The system includes an event collection module implemented by the computer-executable code to receive a plurality of events regarding a transient and dynamic point of attraction from the mobile computing devices within the geographical area. Each event includes a location of one of the mobile computing devices that captured a photograph of the transient and dynamic point of attraction, and a compass direction the one of the mobile computing devices was facing when the photograph was captured. The system includes a location determination module implemented by the computer-executable code to determine a location of the transient and dynamic point of attraction within the geographical area from the events.

### BRIEF DESCRIPTION OF THE SEVERAL VIEWS OF THE DRAWINGS

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1 is a flowchart of an example method for determining a transient and dynamic point of attraction.

FIG. 2 is a diagram of an example map illustratively depicting example performance of the method of FIG. 1.

FIG. 3 is a diagram of an example architecture including mobile computing devices and a computing system, and in which the method of FIG. 1 can be performed.

FIG. 4 is a block diagram of an example computing system that can be used in the example architecture of FIG. 3.

FIG. 5 is a block diagram of an example mobile computing device that can be used in the example architecture of FIG. 3.

### DETAILED DESCRIPTION

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure.

As noted in the background section, mobile computing devices that include wireless data communication, digital photograph capture, and other capabilities have become commonplace. Users of these devices have increasingly leveraged their mobile computing devices in ways that may have been considered unimaginable beforehand. For example, users commonly take photographs in increasing numbers, since they usually have their smartphones with them at all times, whereas before, users only took pictures when they had previously planned to do so and thus had purposefully brought along a separate digital or analog camera.

Therefore, users many times seek out photo-taking opportunities. Such opportunities are difficult to discover, however. For example, a user may be visiting a zoo or other public attraction. The user may be able to call up a map on his or her mobile computing device that shows the locations of various exhibits within the zoo. However, at any given time, a particular exhibit may not afford itself as an especially good photo-taking opportunity. The animals at the exhibit may be sleeping, or the exhibit may even be temporarily closed.

As another example, a user may be attending a wedding held at a relatively large venue. Knowing where good photo-taking opportunities are at any given moment in time is difficult to assess, and generally occurs by happenstance. The user may be in the chapel area of the venue, for instance, not knowing that the bride and groom are currently present at an outdoor gazebo and posing for pictures that are being taken by the other guests.

Techniques disclosed herein alleviate these and other difficulties with learning in real-time about current transient and dynamic points of attraction that may serve as good photo-taking opportunities but that may be short-lived, and that may be moving and not fixed in place. In general, events regarding such a point of attraction within a geographical area are received. Each event includes at least the location at which a photographer captured a photograph of the point of attraction and a compass direction the photographer was facing when capturing the photograph, and may also include the time at which the photograph was captured. From this information, the location of such a point of attraction can be determined.

In particular, from all the events that are received, the events can be culled down to those occurring within a same predetermined period of time before or at the current time. For each such event, a line is extrapolated from the location at which the photograph was captured along the compass direction the photographer was facing when he or she captured the photograph. The intersection area of all the extrapolated lines is therefore the current location of a transient and dynamic point of attraction within the geographical area, and can be transmitted to other users in the same geographical area to inform them of this potential photo-taking opportunity.

The points of attraction are not known beforehand, and are not preordained. As events are received, lines are extrapolated from the information contained therein to determine such transient and dynamic points of attraction, if any. As the events grow stale, the points of attraction correspondingly decay away. Therefore, a user within a given geographical area is provided with a live view of the current transient and dynamic points of attraction as these points of attraction occur and disappear.

For instance, as to the zoo example described above, the zookeepers may be currently feeding the lions at the corresponding exhibit. The visitors that happen to be at the lion exhibit will likely start taking photographs of this point of attraction for the duration of feeding. Events are correspondingly generated by the users' mobile computing devices, and sent wirelessly to a central computing system that determines that a transient and dynamic point of attraction is occurring, and the location thereof. Other visitors of the zoo may then be informed via their mobile computing device of the existence of this point of attraction, such as by an alert like a text message, and call up the location on a map so that they, too, can take pictures. When feeding time is over, the number of events received by the computing system naturally declines, due to less pictures being taken, ultimately resulting in this point of attraction decaying away.

As to the wedding example described above, guests attending the wedding may similarly receive information regarding a transient and dynamic point of attraction corresponding to the bride and groom being at the gazebo. Furthermore, as the bride and groom move from the gazebo to another location at the venue, the number of pictures being taken of them may not decrease. Therefore, the point of attraction in effect slowly moves with the bride and groom—as the bride and groom make their way to another area of the venue, so too does the point of attraction. This means that guests can be informed at any given time as to where good picture-taking opportunities are occurring, in real-time, even as those opportunities track moving points of attraction.

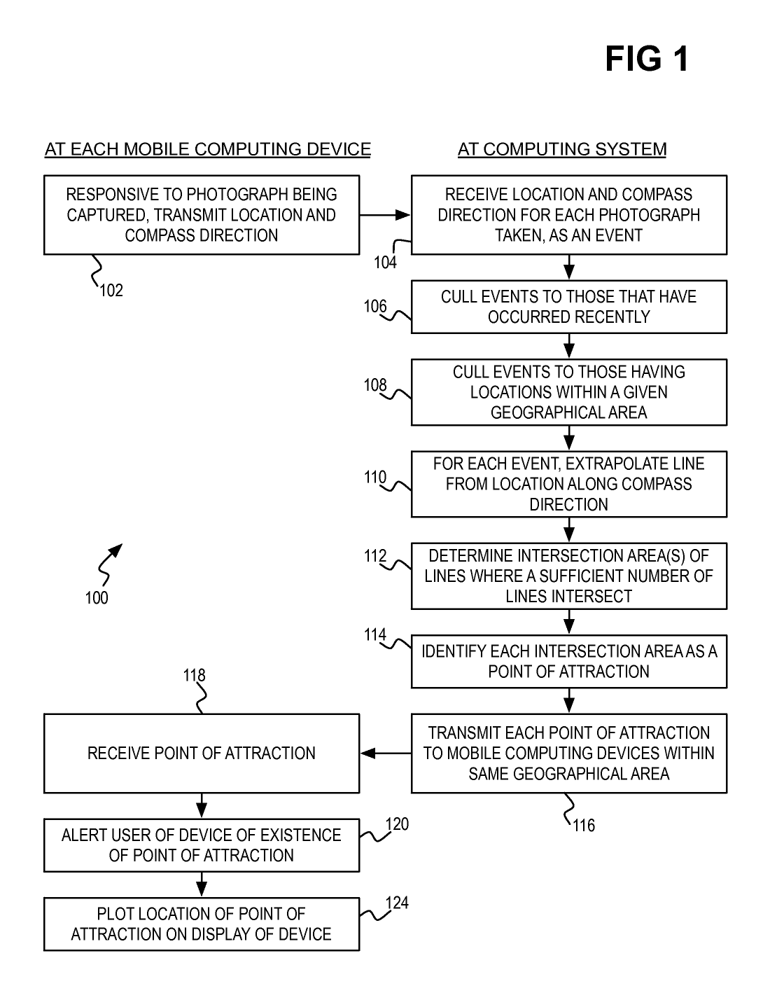

FIG. 1 shows an example method 100. The left-hand parts of the method 100 are performed at each of a number of mobile computing devices, such as smartphones and other such devices. The right-hand parts of the method 100 are performed at a central computing system, such as which may include one or more server computing devices. At least some parts of the method 100 may be considered as identifying the existence of and determining the location of a transient and dynamic point of attraction.

As each mobile computing device is used to capture a digital photograph, at least the location of the mobile computing device and the compass direction the device was facing at the time of capture are transmitted (102). This information corresponds to the location at which the photographer is capturing what he or she perceives to be a point of attraction, insofar as the photographer deems it worthy to capture a picture, and the compass direction the photographer was facing when capturing the photo. The compass direction is presumed to be pointed towards the point of attraction in question.

This information is transmitted wirelessly to the computing system, which receives the location and compass direction for each photograph taken by each mobile computing device, as an event (104). The event can also be said to include a time at which the picture was captured. The time may be transmitted in part 102, or the computing system itself may regard this time as the time at which it received the location and compass direction in question in part 104.

The computing system is considered to cull, or consider, just those events that have recently occurred (106). Stated another way, the events are limited to those that have occurred at the same time, within a threshold. In another implementation, the events may be weighted by how long ago they occurred, where events occurring now are maximally weighted, and events occurring in the distant past minimally weighted.

The computing system further is said to cull, or consider, just those events that have locations within the same geographical area (108), as follows. Specifically, for each event, the computing system extrapolates a line of a given length from the location of the event along the compass direction of the event (110). Each line can have a same length, which may be specified in advance or dynamically determined.

For example, for a given point of attraction, some photographers may be located a few feet away, whereas other photographers may be located several yards away. However, it is unlikely that photographers hundreds of feet away but taking photos along the same compass direction are taking pictures of the same point of attraction in a smaller venue, like an indoor venue. By comparison, in a larger venue, like an outdoor venue, all of these photographers may be taking photos of the same point of attraction. Therefore, although each line can have the same predetermined length corresponding to the distance at which a photographer is likely to be maximally away from the point of attraction of which he or she is taking a picture, in other implementations, the lengths of the lines that are extrapolated are dynamically determined based on the likely venue types in which the photographers are located.

The computing system determines intersection areas of lines, where a sufficient number of such lines intersect (112). The number of lines that is considered sufficient to warrant an intersection area may also be specified in advance or dynamically determined. For example, for a sporting event that tens of thousands of people are attending, the fact that ten people are taking pictures of the same thing is not likely to be sufficient to signify that a transient and dynamic point of attraction is occurring. For a smaller event like a wedding, by comparison, this fact may be considered to be sufficient to conclude that a point of attraction is underway. Therefore, the number of lines that have to intersect for the computing system to consider the resulting intersection as an intersection area that is a point of attraction may be the same regardless of venue, or may vary. Furthermore, if the events are weighted as noted above, each line may be weighted by its corresponding event's weight in consideration of whether this sufficient number has been achieved.

An intersection area of lines is further not necessarily a true intersection, but takes into account that different photographers may be taking photos of the same point of attraction but of slightly different parts thereof, as well as that the locations and compass directions of the events may be imprecise to some extent. Therefore, an intersection area may be considered a sufficiently sized circle through which lines pass. The size of the circle may vary or be specified in consideration of the assumed precision of the events' locations and compass directions, as well as on the type of venue—the latter in the same way in which the length of the lines and the number of lines are dependent on the venue type.

Each such intersection area is identified as a currently occurring transient and dynamic point of attraction (114), the location of each of which may be considered as the center of the circle corresponding to the intersection area in question. Such a point of attraction is transient in that it may have a short timespan. For example, the feeding of the lions in the zoo example noted above will last only a short while, even though the lion exhibit itself remains after feeding. Such a point of attraction is dynamic in that the point of attraction is not preordained or predetermined. For example, the presence a celebrity on the streets of a major city that results in significant picture-taking may not be preordained or predetermined, but rather may result from the celebrity just happening to be taking his or her dog on a walk. Such a point of attraction is further dynamic in that the point of attraction slowly moves within the geographical area. For example, the bride and groom in the wedding example noted above may walk together from the chapel to another location within the venue, where wedding guests are constantly taking photos of them as they walk.

For each point of attraction, the computing system transmits the location of the point of attraction to mobile computing devices currently located within the same geographical area (116). A mobile computing device (i.e., and its user) may be considered to be in the same geographical area as a point of attraction if the device is no farther than a given distance away from the point of attraction. This distance may be set by the user in a manual manner, or the computing system may determine the distance itself, such as based on the type of venue in which the mobile computing device is located.

A mobile computing device thus receives a point of attraction within its same geographical area (118), and if the user thereof has previously requested, can alert the user to the existence of this nearby point of attraction (120). For instance, a message may be displayed on the user's mobile computing device, or a sound may be made by the mobile computing device. If the user so desired, the mobile computing device can plot the location of each nearby point of attraction on a display of the device (122), as well as the user's current location, so that the user can decide for him or herself whether the user wishes to visit any such identified point of attraction. The user may further be able to navigate a map on his or her mobile computing device, where the mobile computing device retrieves from the computing system any points of interest within the currently displayed region of the map for indicating thereon.

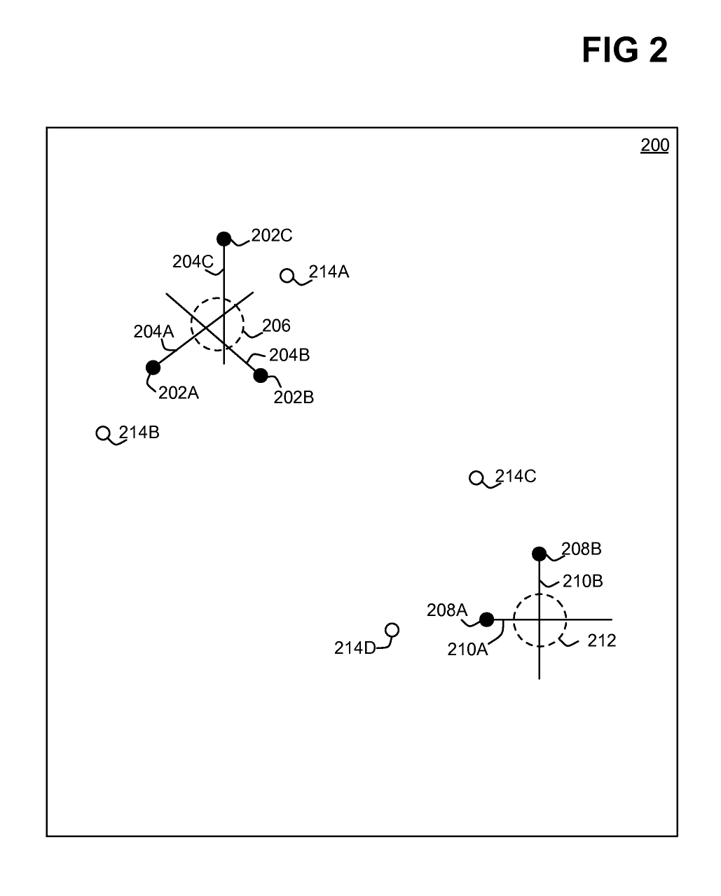

FIG. 2 shows an example map 200 illustratively depicting example performance of the method 100. Solid dots 202A, 202B, and 202C, and solid dots 208A and 208B, which are collectively referred to as the solid dots 202 and 208, respectively, correspond to the locations of mobile computing devices from which events have been recently received. Hollow dots 214A, 214B, 214C, and 214D, collectively referred to as the hollow dots 214, correspond to the locations of mobile computing devices from which events that have not been recently received.

Lines 204A, 204B, and 204C, collectively referred to as the lines 204, extend from the solid dots 208 along compass directions of their respective events. The result is a dotted circle 206 in which it is said that the lines 204 intersect. Note, however, that the three lines 204 do not actually intersect at a given point; rather, each different pair of lines 204 intersect at a different point, but all three of these points of intersection are within the dotted circle 206.

It may be determined for the map 200, that so long as at least three lines intersect in a given dotted circle, the corresponding area of intersection is deemed to correspond to a transient and dynamic point of attraction. Therefore, because there are three lines 204 that intersect in the dotted circle 206, the dotted circle 206 is said to correspond to a point of attraction. The existence and location of this point of attraction is transmitted to other mobile computing devices represented by the hollow dots 214 that are within the same geographic area. For instance, the devices corresponding to the hollow dots 214A and 214B may be sufficiently close to the point of attraction corresponding to the dotted circle 206 that they are transmitted the existence and location of this point of attraction. By comparison, the mobile computing devices corresponding to the hollow dots 214C and 214C may not be, and thus are not transmitted the existence and location of the point of attraction corresponding to the dotted circle 206.

Lines 210A and 210B, collectively referred to as the lines 210, extend from the solid dots 208 along compass directions of their respective events. The result is a dotted circle 212 encompassing the point of intersection of the two lines 210. However, because just two lines intersect in the dotted circle 212, the corresponding area of intersection is not deemed to correspond to a transient and dynamic point of interest. Therefore, no mobile computing devices are informed that a corresponding point of interest is occurring, including the devices corresponding to the solid dots 214C and 214D that are sufficiently close such that they otherwise would be.

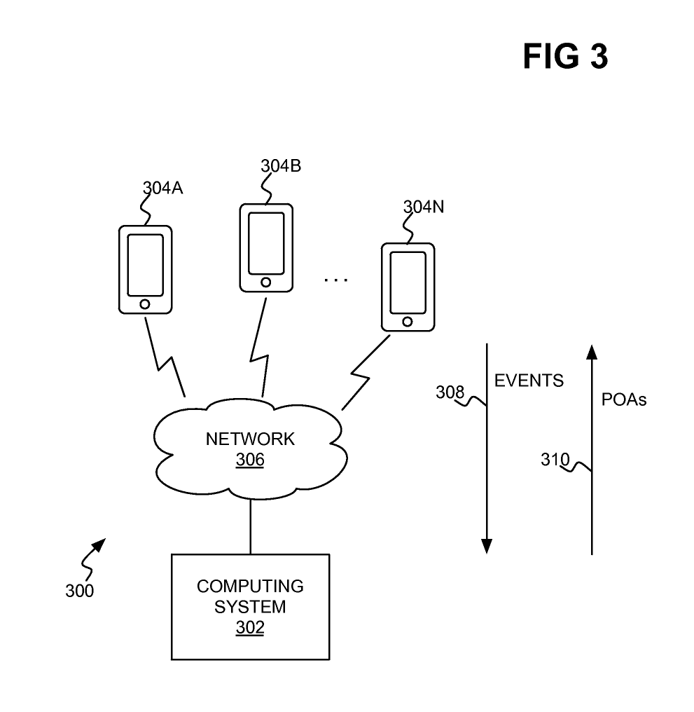

FIG. 3 shows an example topographical architecture 300 in relation to which the method 100 can be implemented. The architecture 300 includes a computing system 302 and a number of mobile computing devices 304A, 304B, . . . , 304N, which are collectively referred to as the mobile computing devices 304. The computing system 302 and the mobile computing devices 304 are communicatively interconnected to one another over a network 306.

The computing system 302 may include one or more server computing devices, and typically has a wired connection to the network 306, although the computing system 302 may instead have a wireless connection to the network 306. The mobile computing devices 304 can include smartphones, smart digital camera devices, and other types of mobile computing devices. The mobile computing devices 304 typically have wireless connections to the network 306.

The network 306 usually includes at least a wireless network, such as a telephony network like the third-generation (3G) network, a fourth-generation (4G) network like the long-term evolution (LTE) network. The wireless network may further or alternatively be or include a Wi-Fi network or another type of wireless network, such as a Bluetooth network, or a wireless Ethernet network other than a Wi-Fi network. The network 306 can include a wired network as well, such as a wired Ethernet network. The network 306 can also be said to be or include a local-area network (LAN), a wide-area network (WAN), an intranet, an extranet, the Internet, and so on.

In the architecture of FIG. 3, events 308 are generated by and transmitted from the mobile computing devices 304 to the computing system 302 over the network 306. Each event 308 includes at least the location of a mobile computing device that captured a photograph and the compass direction that this device was facing when the photograph was captured, and may also include the time at which the photograph was captured, as noted above. From these events 308, the computing system 302 identifies and determines the location of transient and dynamic points of attraction 310, and for each such point of attraction 310, notifies the mobile computing devices 304 within the same geographic area of its location.

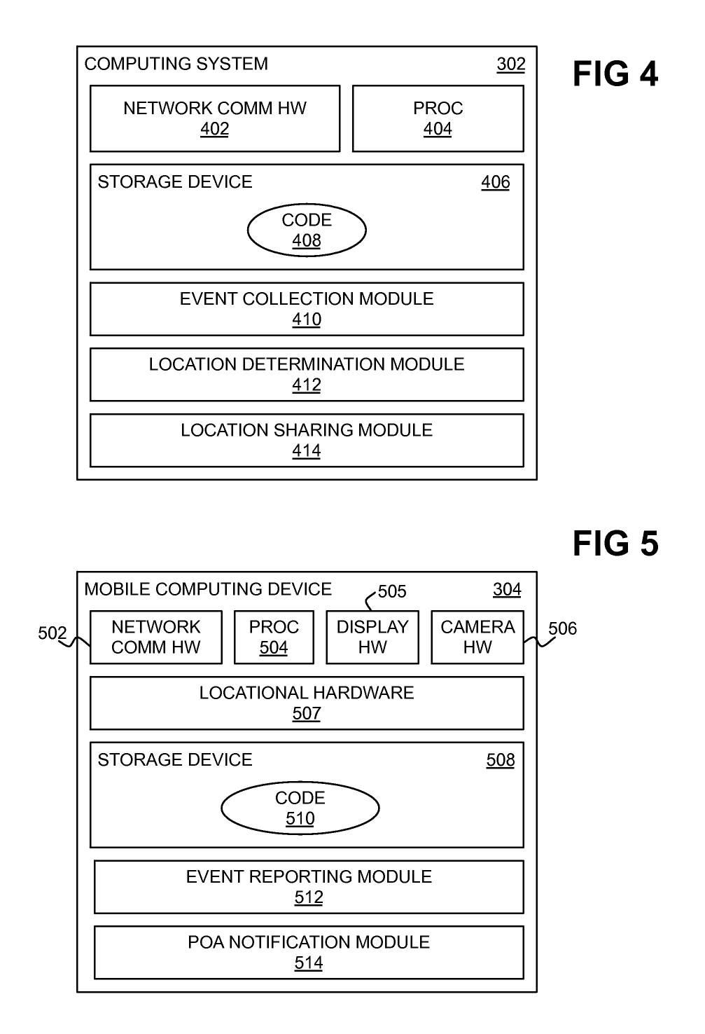

FIG. 4 shows the computing system 302 in example detail. The computing system 302 includes network communication hardware 402, a processor 404, and a storage device 406, and may include additional or other components in lieu of those depicted in FIG. 4. The network communication hardware 402 permits the computing system 302 to communicate over the network 306, and thus with the mobile computing devices 304. The storage device 406 stores computer-executable code 408 that is executable by the processor 404.

The computer-executable code 408 is said to implement an event collection module 410, a location determination module 412, and a location sharing module 414. The event collection module 410 collects the events 308 from the mobile computing devices 304, and thus performs part 104 of the method 100. The location determination module 412 determines the existence and location of transient and dynamic points of attraction 310, and thus performs parts 106, 108, 110, 112, and 114 of the method 100. The location sharing module 414 shares the existence and location of each point of attraction 310 with those mobile computing devices 304 within the same geographic area as the point of attraction 310 in question, and thus performs part 116 of the method 100.

FIG. 5 shows a mobile computing device 304 in example detail. The mobile computing device 304 includes network communication hardware 502, a processor 504, display hardware 505, camera hardware 506, location hardware 507, and a storage device 508, and may include additional or other components in lieu of those depicted in FIG. 5. The network communication hardware 502 permits the mobile computing device 304 to communicate over the network 306, and thus with the computing system 302. The display hardware 505 permits the mobile computing device 304 to display information to a user thereof, and may include a liquid-crystal display (LCD), for instance, and the camera hardware 506 permits the device 304 to capture digital photographs. The locational hardware 507 permits the mobile computing device 304 to determine its current location and the direction in which it is facing, and in this respect can include GPS hardware and compass-oriented hardware. The storage device 508 stores computer-executable code 510 executable by the processor 504.

The computer-executable code 510 is said to implement an event reporting module 512 and a point of attraction notification module 514. The event reporting module 512 transmits at least the location of the mobile computing device 304 and the compass direction that the device 304 is facing when a photograph is taken, as an event 308, to the computing system 302. It is noted that the photograph that is taken may not and generally is not transmitted to the computing system 302, however. The event reporting module 512 thus performs part 102 of the method 100.

The point of attraction notification module 514 receives the existence and location of a point of attraction 310 from the computing system 302. The module 514 then may alert the user of the mobile computing device 304 that a nearby point of attraction 310 has been detected, and may plot the location of the point of attraction 310 on a map displayed by the display hardware 505. The point of attraction notification module 514 thus performs parts 118, 120, and 122 of the method 100.

It is noted that, as can be appreciated by one those of ordinary skill within the art, aspects of the present invention may be embodied as a system, method or computer program product. Accordingly, aspects of the embodiments of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

In general, a computer program product includes a computer-readable medium on which one or more computer programs are stored. Execution of the computer programs from the computer-readable medium by one or more processors of one or more hardware devices causes a method to be performed. For instance, the method that is to be performed may be one or more of the methods that have been described above.

The computer programs themselves include computer program code. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

We claim:

1. A method comprising:
receiving, by a computing device, a plurality of events regarding a transient and dynamic point of attraction within a geographical area, each event including:
a location at which a photographer captured a photograph of the transient and dynamic point of attraction; and
a compass direction the photographer was facing when capturing the photograph; and
determining, by the computing device, a location of the transient and dynamic point of attraction within the geographical area from the events.

2. The method of claim 1, wherein each event further includes a time at which the photographer captured the photograph.

3. The method of claim 1, wherein determining the location of the transient and dynamic point of attraction within the geographical area comprises:
for each event, extrapolating a line from the location at which the photographer captured the photograph along the compass direction the photographer was facing when capturing the photograph; and
determining an intersection area of the lines extrapolated for the events, as the location of the transient and dynamic point of attraction within the geographical area.

4. The method of claim 3, wherein each event further includes a time at which the photographer captured the photograph, and wherein determining the location of the transient and dynamic point of attraction within the geographical area comprises:
limiting the events from which the lines are extracted for determining the intersection area as the events of which the times the photographers captured the photographs are identical within a threshold.

5. The method of claim 1, further comprising:
transmitting the location of the transient and dynamic point of attraction within the geographical area from the computing device to a mobile device of a user located within the geographical area.

6. The method of claim 1, wherein the transient and dynamic point of attraction is transient in that the point of attraction has a short timespan.

7. The method of claim 6, wherein the transient and dynamic point of attraction is dynamic in that the point of attraction is not preordained or predetermined.

8. The method of claim 6, wherein the transient and dynamic point of attraction is dynamic in that the point of attraction slowly moves within the geographical area.

9. A computer program product comprising:
a storage device storing computer-executable code that is executable by a mobile computing device to perform a method comprising:
receiving a location of a transient and dynamic point of attraction within a geographical area in which the mobile computing device is located, the location determined from a plurality of events regarding the transient and dynamic point of attraction that each include:
a location at which a photographer captured a photograph of the transient and dynamic point of attraction; and
a compass direction the photographer was facing when capturing the photograph; and
indicating the location of the transient and dynamic point of attraction within a map displayed on the mobile computing device.

10. The computer program product of claim 9, wherein each event further includes a time at which the photographer captured the photograph.

11. The computer program product of claim 9, wherein the mobile computing device has photographic capability, and the method further comprises:
responsive to the mobile computing device capturing a photograph via the photographic capability thereof, transmitting an event to a remote computing device, the event including:
a location of the mobile computing device at which the photograph was captured; and
a compass direction the mobile computing device was facing when the photograph was captured.

12. The computer program product of claim 11, wherein the event further includes a time at which the photograph was captured.

13. The computer program product of claim 9, wherein the transient and dynamic point of attraction is transient in that the point of attraction has a short timespan.

14. The computer program product of claim 13, wherein the transient and dynamic point of attraction is dynamic in that one or more of:
the point of attraction is not preordained or predetermined;
the point of attraction slowly moves within the geographical area.

15. A system comprising:
network communication hardware to communicate with a plurality of mobile computing devices located within a geographical area;
a processor;
a storage device storing computer-executable code executable by the processor;
an event collection module implemented by the computer-executable code to receive a plurality of events regarding a transient and dynamic point of attraction from the mobile computing devices within the geographical area, each event including:
a location of one of the mobile computing devices that captured a photograph of the transient and dynamic point of attraction; and
a compass direction the one of the mobile computing devices was facing when the photograph was captured; and
a location determination module implemented by the computer-executable code to determine a location of the transient and dynamic point of attraction within the geographical area from the events.

16. The system of claim 15, wherein the location determination module determines the location of the transient and dynamic point of attraction within the geographical area by:
for each event, extrapolating a line from the location thereof along the compass direction thereof; and
determining an intersection area of the lines extrapolated for the events, as the location of the transient and dynamic point of attraction within the geographical area.

17. The system of claim 16, wherein each event further includes a time at which the photographer captured the photograph, and wherein the location determination module determines the location of the transient and dynamic point of attraction within the geographical area by further:
limiting the events from which the lines are extracted for determining the intersection area as the events of which the times the photographers captured the photographs are identical within a threshold.

18. The system of claim 15, further comprising:
a location sharing module implemented by the computer-executable code to transmit the location of the transient and dynamic point of attraction within the geographical area to one or more of the mobile computing devices located within the geographical area.

19. The system of claim 15, wherein the transient and dynamic point of attraction is transient in that the point of attraction has a short timespan.

20. The system of claim 15, wherein the transient and dynamic point of attraction is dynamic in that one or more of:
the point of attraction is not preordained or predetermined;
the point of attraction slowly moves within the geographical area.
